(19) United States
(12) Patent Application Publication
(10) Pub. No.: US 2014/0106039 A1
(43) Pub. Date: Apr. 17, 2014

(54) METHOD FOR PRODUCING CONFECTIONERY

(71) Applicant: BAHLSEN GmbH & Co. KG, Hannover (DE)

(72) Inventors: Karsten Grove, Schellerten (DE); Martin Habbel, Bielefeld (DE)

(73) Assignee: BAHLSEN GmbH & Co. KG, Hannover (DE)

(21) Appl. No.: 14/117,744

(22) PCT Filed: Apr. 27, 2012
(86) PCT No.: PCT/EP2012/001828

§ 371 Date: Dec. 17, 2013

(30) Foreign Application Priority Data
May 17, 2011 (DE) 10 2011 108 562.2

(51) Int. Cl. A21D 13/00

(52) U.S. Cl. CPC A21D 13/0009
USPC 426/303

(57) ABSTRACT

The present invention relates to a method for producing confectionery comprising the following method steps: producing a long-life bakery product, the long-life bakery product being provided with at least one surface for applying a mass comprising chocolate or fat-based glaze, producing the mass comprising chocolate or fat-based glaze, applying a binder in a liquid phase or in a gaseous phase to the surface, and applying the mass comprising chocolate or fat-based glaze to the surface wetted with the binder.

The present invention relates to a method for producing confectionery. In detail, the invention relates to a method for producing confectionery which comprises a long-life bakery product on which a cluster of chocolate and cereals or similar products is arranged.

It is known from the prior art that long-life bakery products, particularly biscuits, are covered with chocolate and/or provided with a chocolate coating. In the case of a sufficient amount of chocolate such a cover or coating adheres thereto. Also in the case of a cereal/chocolate cluster with a very high chocolate content an adequate adhesion is achievable.

It is the object of the present invention to provide a method of the aforementioned type which permits the production of tender, flavor-optimized confectionery.

According to the invention this object is achieved through the feature combination of claim 1; the sub claims show further advantageous developments of the invention.

Hence, according to the invention it is intended that a long-life bakery product is first of all produced. Preferably, this product is configured in the form of a biscuit, for example in the form of a standard shortbread.

The following definition is given within the scope of the invention:
Long-life bakery product: long-life bakery products are “fine bakery products”;
Fine bakery products are produced from doughs or masses by baking, roasting, drying, cooking extrusion, or other methods;
The doughs are prepared by using cereals and/or cereal products, starches, fats, sugars;
They are distinguished from bread and small baked products in that they contain more sugar and fat, but also less moisture;
Long-life bakery products are fine bakery products which are long-lasting;
Shortbread: short biscuit contains at least 16.5 kg of virtually water-free fats or a corresponding amount of other fats based on 100 kg cereal products and/or starches.

Leitsätze 2010, B. Behr's Verlag GmbH & Co.KG, Hamburg, 2^{nd} edition 2010, page 45+56, Leitsätze für Feine Backwaren, ISBN: 978-3-89947-740-5.

The long-life bakery product is produced by making a dough, by shaping the dough, optionally by applying a coat, by baking and by approval and inspection of the semifinished products.

The above-mentioned optional application of a coat after dough formation is optional. The coat improves the coloration and gloss of the long-life bakery product; a darker coloration is particularly achieved.

The long-life bakery product is produced according to the invention in such a manner that it is provided with at least one surface for applying a mass comprising chocolate or fat-based glaze. This surface thus serves to fix a mixture (cluster, small heap) of chocolate or fat-based glaze and other substances to the long-life bakery product.

Chocolate and fat-based glaze, respectively, means the following according to the invention:

Chocolate: product consisting of cacao products and sugars, which contains at least 35% total dry cacao solids, of this at least 18% cacao butter and at least 15% dry non-fat cacao solids.

Fat-based glaze: in comparison with chocolate, fat-based glaze contains no cacao butter; hardened vegetable fats are used.

Preferably, e.g. the following main constituents are used in the dough composition for producing the long-life bakery product:

| | |
|---|---|
| Flour | 50-60% |
| Fat | 10-15% |
| Sugar | 15-20% |

According to the invention it is particularly advantageous when the long-life bakery product is produced in the form of a biscuit, particularly a flat biscuit. It is particularly advantageous when the surface for applying the mass comprising the chocolate or fat-based glaze is made flat. It goes without saying that other surface configurations are also possible, depending on the desired overall shape and the appearance of the confectionery.

It is particularly advantageous when the surface for applying the mass comprising the chocolate or fat-based glaze is provided with a patterned or structured surface design. The active surface is thereby increased in addition.

According to the method of the invention it is intended as a subsequent method step after manufacture of the long-life bakery product to prepare the mass comprising the chocolate or fat-based glaze. To this end chocolate is mixed with further elements, particularly with cereals, resulting in a cereal/chocolate cluster. The cereals which can be used may be cereal flakes, e.g. cornflakes, also puffed cereals, e.g. crispies, but also flakes, such as oat flakes, and/or pieces of nut fruits, e.g. hazelnut, peanut, macadamia, or the like. Apart from chocolate, the used cluster constituents are preferably cornflakes, but other cereal extrudates, cereal flakes, crisp raw materials (so-called crispies), piece goods, e.g. nuts or nut pieces, fruit pieces, raisins, currants, long-life bakery product pieces, biscuit pieces or crispbread pieces may be used.

On the whole a cluster with a relatively low chocolate content is produced according to the invention, the chocolate content being preferably more than 50%, but it may also be less according to the invention. A low chocolate content yields a tender form of the cluster which gives a positive sensory feeling during consumption.

The cereal/chocolate cluster is prepared by adding the cereals to the molten chocolate. The cereals are transported by means of a mixing screw, weighed and then mixed with the chocolate. Subsequently, the cereal/chocolate cluster is supplied in metered amounts to apply an exact quantity to each of the long-life bakery products (biscuit, shortbread, or the like).

In a preferred composition, the cereal/chocolate cluster comprises e.g. 30% cereals and 70% chocolate or 35% cereals and 65% chocolate or 25% cereals and 75% chocolate.

Before the cereal/chocolate cluster is applied according to the invention to the surface of the long-life bakery product, a binder (joining agent) is applied to the surface. According to the invention it is preferably applied in a liquid phase or a gaseous phase. The binder accomplishes a firm permanent adhesion of the cluster to the long-life bakery product.

According to the invention a sugar/water solution, a fat/water emulsion and/or a water/starch solution and/or water is for example used as the binder. According to the invention combinations of said compositions of the binder are also possible.

According to the invention the binder may be applied in dot form, stripe form or in a planar manner onto the surface. In the case of a dot-shaped or drop-shaped application four to nine individual drops are e.g. particularly advantageous. These merge with one another, resulting in the formation of a closed binder area on the surface of the biscuit.

Preferably, the amount of the binder is chosen according to the invention such that on the one hand it wets the surface of the long-life bakery product to which the cereal/chocolate cluster is applied, and that on the other hand the moisture of the long-life bakery product is increased only insignificantly.

Depending on the size of the long-life bakery product, it is e.g. advantageous to apply 0.02 to 0.08 g, preferably 0.04 to 0.06 g, of the binder, e.g. water, in the case of a biscuit. This would have the effect that the moisture is only increased by 1% at the most. Hence, the total product moisture of the finished confectionery is increased such that it does not exceed a maximum value so as to guarantee the desired minimum storage life. For instance, a maximal residual moisture of the product of not more than 3% may be intended.

Furthermore, it may be particularly advantageous according to the invention when not the whole surface of the long-life bakery product to be covered with the cereal/chocolate cluster is provided with the binder. Rather, it may be sufficient to apply the binder to a part of the area, e.g. 50%-60%, to ensure a good adhesion between the cereal/chocolate cluster and the long-life bakery product.

It is particularly advantageous when the period between the application of the binder and the application of the cereal chocolate cluster is relatively short, i.e., not longer than 60 seconds.

To be able to meter the binder in precise amounts, it is particularly advantageous when small individual drops of the binder are applied. However, it is also possible to atomize the binder, similar to a gaseous phase, or to use ultrasonic application.

The surface of the long-life bakery product which has the cereal/chocolate cluster applied thereto may be flat, but it is also possible to provide it with a raised edge, e.g. in the form of a depression.

According to the invention the form of the long-life bakery product may have different geometric shapes, e.g. square, rectangular, triangular, circular or in any other forms.

The biscuits as well as the flakes should preferably have a temperature of about 25° C. to 29° C. during refining (filling with the cluster).

The processing temperature of the liquid tempered chocolate is preferably about 28° C. to 30° C.

According to the invention cooling may be carried out in a further process step to cool and crystallize the chocolate material, e.g. over a cooling period of 15 to 20 minutes and at a cooling temperature of 16° C. to 20° C.

The invention will now be described with reference to embodiments in conjunction with the drawing, in which

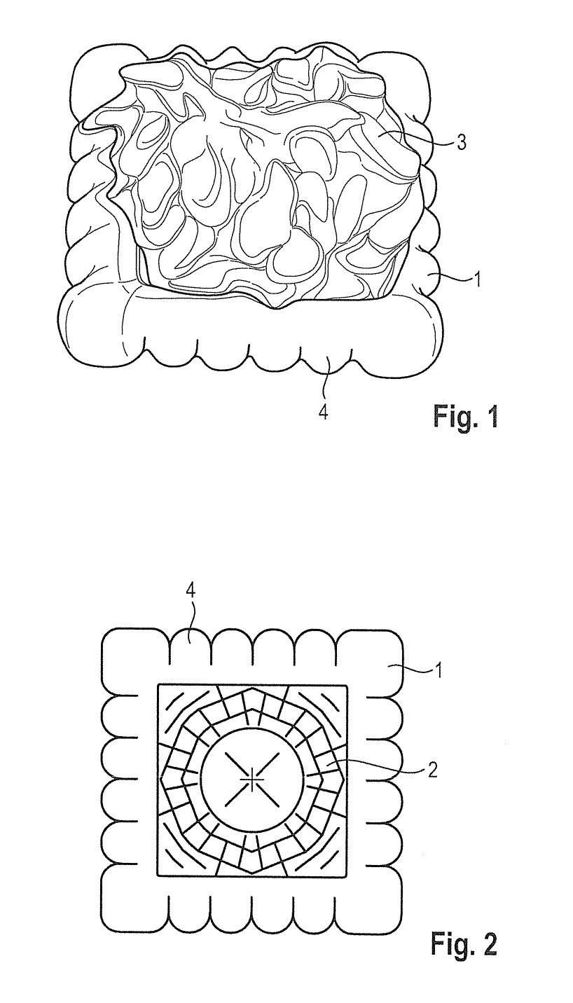

FIG. 1 is a schematic perspective view of a finished confectionery product according to the invention; and

FIG. 2 is a schematic top view on the long-life bakery product with the surface to be covered with the cereal/chocolate cluster.

In the illustrated embodiment a long-life bakery product 1 is produced in the form of a flat biscuit in a square shape. The long-life bakery product 1 has a surface 2 which is made substantially flat and is provided with a pattern or structure for increasing the active surface, as is schematically shown in FIG. 2.

The surface 2 is formed by a raised edge 4, resulting in a depression into which a mass 3 comprising chocolate or fat-based glaze (cereal/chocolate cluster) is introduced.

The edge 4 is provided with a coat before the long-life bakery product 1 is baked so as to improve the surface by way of coloration and/or gloss.

After the mass 3 comprising the chocolate or fat-based glaze has been applied, the confectionery is cooled and subsequently packaged.

It goes without saying that the surface can be structured (see FIG. 2) also in a different way, e.g. by way of a dot pattern, by a further line pattern, or the like.

In the illustrated embodiment the wetting of the binder can be carried out by applying individual water drops that are wetting the surface 2. It is here sufficient when a part of the surface 2 is wetted, e.g. 50% to 60% of the surface 2.

### LIST OF REFERENCE NUMERALS

1 long-life bakery product
2 surface
3 mass comprising chocolate or fat-based glaze/cereal-chocolate cluster
4 edge

1. A method for producing confectionery comprising the following method steps:
producing a long-life bakery product,
the long-life bakery product being provided with at least one surface for applying a mass comprising chocolate or fat-based glaze,
producing the mass comprising chocolate or fat-based glaze,
applying a binder in a liquid phase or in a gaseous phase to the surface, and
applying the mass comprising chocolate or fat-based glaze to the surface wetted with the binder.

2. The method according to claim 1, characterized in that the long-life bakery product is produced in the form of a biscuit, particularly a flat biscuit, particularly with a flat surface for applying the mass comprising chocolate or fat-based glaze, particularly with a structured surface.

3. The method according to claim 1, characterized in that a sugar/water solution and/or a fat/water emulsion and/or a water/starch solution and/or water is used as the binder, particularly by application in dot shape or stripe shape or in a planar manner.

4. The method according to claim 1, characterized in that the residual moisture of the finished long-life bakery product is increased by 0.5% to 1.5% by applying the binder.

5. The method according to claim 1, characterized in that the mass comprising the chocolate or fat-based glaze is produced with a chocolate content of more than 50% and by adding cereals, the cereals particularly comprising cereal flakes, puffed cereals, flakes, and/or pieces of nut fruits.

6. The method according to claim 1, characterized in that the period between the application of the binder and the mass comprising the chocolate or fat-based glaze is 30 to 45 seconds.

7. The method according to claim 1, characterized in that the binder is applied to 35% to 75% of the contact area of the surface with the mass comprising the chocolate or fat-based glaze.

8. The method according to claim 1, characterized in that the surface of the long-life bakery product is configured in the form of a depression with raised edge or is made smooth or planar.

9. The method according to claim 1, characterized in that the binder is applied in the form of drops or as mist and/or by ultrasonic humidification.

10. The method according to claim 1, characterized in that the confectionery is cooled after application of the mass comprising the chocolate or fat-based glaze.
